(19) United States
(12) Patent Application Publication
(10) Pub. No.: US 2024/0201980 A1
(43) Pub. Date: Jun. 20, 2024

(54) Firmware update method having self-restoration mechanism

(71) Applicant: Suzhou PanKore Integrated Circuit Technology Co. Ltd., Suzhou City (CN)

(72) Inventors: JUN-MEI XU, Suzhou City (CN); XIAO-DAN XU, Suzhou City (CN); XU-LIANG SHEN, Suzhou City (CN)

(21) Appl. No.: 18/198,421

(22) Filed: May 17, 2023

(30) Foreign Application Priority Data
Dec. 15, 2022 (CN) 202211615817.0

(51) Int. Cl. G06F 8/658; G06F 11/14

(52) U.S. Cl. CPC G06F 8/658; G06F 11/1433

(57) ABSTRACT

A firmware update method having a self-restoration mechanism is performed by a terminal device. The firmware update method includes the following steps: downloading a differential upgrade package and a differential restoration package through a communication network channel; performing an upgrade operation to current firmware of the terminal device with the differential upgrade package to upgrade the current firmware to a target firmware, wherein the current firmware is changed into incompletely-upgraded firmware after the upgrade operation starts and before the upgrade operation finishes successfully; and verifying whether the upgrade operation fails, and when the upgrade operation fails, performing a restoration operation to the incompletely-upgraded firmware with the differential restoration package to restore the incompletely-upgraded firmware to the current firmware.

### BACKGROUND OF THE INVENTION

### 1. Field of the Invention

The present disclosure relates to a firmware update method, especially to a firmware update method having a self-restoration mechanism.

### 2. Description of Related Art

Generally, a terminal device (e.g., an embedded terminal device) has very limited calculation capability and memory resources. When the original firmware of the terminal device needs to be upgraded, this upgrade could be realized with an over-the-air technology (OTA). Methods for realizing the upgrade with the OTA include a whole package upgrade method and a differential upgrade method. Regarding the whole package upgrade method, the terminal device needs to download the whole new firmware (i.e., a whole upgrade package) to replace the original firmware; however, the size of the whole upgrade package is usually very large, and the terminal device usually needs to spend a lot of time to download the whole upgrade package and use a large amount of spared memory of the terminal device to store the package. Accordingly, the user experience is usually not good in regard to the whole package upgrade method, not to mention the terminal device may not have enough spared memory to temporarily store the whole upgrade package. Regarding the differential upgrade method, the terminal device needs to download a differential upgrade package that is generated according to the difference between the original firmware and the new firmware, and then uses the differential upgrade package to upgrade the original firmware of the terminal device. Since the size of the differential upgrade package is very small (e.g., the size of the differential upgrade package may be smaller than ten percent of the size of the new firmware) in comparison with the whole upgrade package, the terminal device can download the differential upgrade package in no time and use a small amount of spared memory to temporarily store the package.

However, the failure rate of the differential upgrade method is higher than the failure rate of the whole package upgrade method. When the terminal device does not successfully upgrade its original firmware with the differential upgrade package, the terminal device is usually dead due to the incomplete firmware.

### SUMMARY OF THE INVENTION

An object of the present disclosure is to provide a firmware update method having a self-restoration mechanism. The method can prevent a terminal device from crashing when the terminal device fails in its firmware update.

An embodiment of the firmware update method of the present disclosure is performed by a server and a terminal device cooperatively. The firmware update method includes the following steps: using the server to obtain to-be-upgraded firmware that is equal to or equivalent to current firmware of the terminal device, and obtain target firmware; using the server to perform a first differential operation to the to-be-upgraded firmware based on the target firmware, and thereby generating a differential upgrade package; using the server to perform a second differential operation to the target firmware based on the to-be-upgraded firmware, and thereby generating a differential restoration package; using the terminal device to download the differential upgrade package and the differential restoration package through a communication channel; using the terminal device to perform an upgrade operation to the current firmware of the terminal device with the differential upgrade package so as to upgrade the current firmware to the target firmware, wherein the current firmware is changed into incompletely-upgraded firmware after the upgrade operation starts and before the upgrade operation finishes successfully; and using the terminal device to verify whether the upgrade operation fails, and when the upgrade operation fails, using the terminal device to perform a restoration operation to the incompletely-upgraded firmware with backup of partial data of the current firmware and/or with the differential restoration package so as to restore the incompletely-upgraded firmware to the current firmware.

Another embodiment of the firmware update method of the present disclosure is performed by a terminal device. The firmware update method includes the following steps: using the terminal device to download a differential upgrade package and a differential restoration package through a communication channel; using the terminal device to perform an upgrade operation to current firmware of the terminal device with the differential upgrade package so as to upgrade the current firmware to the target firmware, wherein the current firmware is changed into incompletely-upgraded firmware after the upgrade operation starts and before the upgrade operation finishes successfully; and using the terminal device to verify whether the upgrade operation fails, and when the upgrade operation fails, using the terminal device to perform a restoration operation to the incompletely-upgraded firmware with backup of partial data of the current firmware and/or with the differential restoration package so as to restore the incompletely-upgraded firmware to the current firmware.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows the firmware update method having a self-restoration mechanism according to an embodiment of the present disclosure.

FIG. 2 shows an embodiment of step S120 of FIG. 1.

FIG. 3 shows an embodiment of step S130 of FIG. 1.

FIG. 4 shows an embodiment of step S150 of FIG. 1.

FIG. 5 shows additional steps optionally included in step S150 of FIG. 1.

FIG. 6 shows an embodiment of the step S160 of FIG. 1.

FIG. 7 shows additional steps optionally included in step S160 of FIG. 1.

### DETAILED DESCRIPTION OF THE PREFERRED EMBODIMENTS

The present specification discloses a firmware update method having a self-restoration mechanism. The method is a type of differential upgrade technologies and can prevent a terminal device from crashing when the terminal device fails in its firmware update.

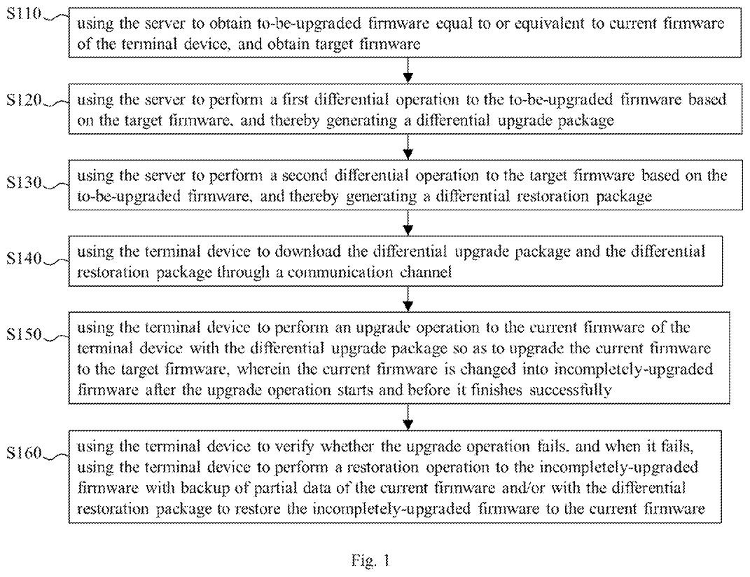

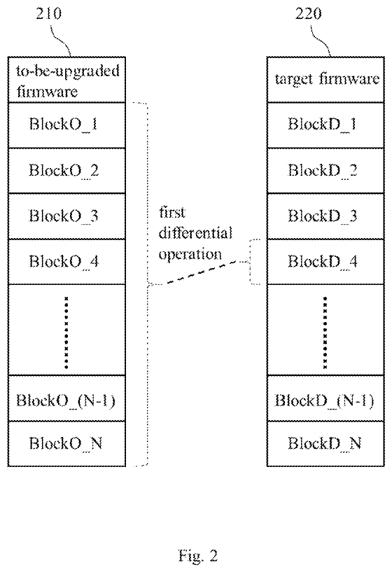

FIG. 1 shows an embodiment of the firmware update method of the present disclosure. The embodiment of FIG. 1 is executed by a sever and a terminal device cooperatively, and includes the following steps:
S110: using the server to obtain to-be-upgraded firmware that is equal to or equivalent to current firmware of the terminal device, and obtain target firmware.
   The server can obtain the target firmware from a firmware source (e.g., a far-end/near-end data server) through a communication network or other media (e.g., wired transmission media). The server can obtain the to-be-upgraded firmware from the terminal device through the communication network or other media (e.g., another communication network), or obtain the to-be-upgraded firmware from the above-mentioned firmware source or another firmware source. An example of the communication network is a wireless communication network including at least one of a WiFi connection, a Bluetooth connection, and a mobile network connection, but the implementation of the present invention is not limited thereto.
S120: using the server to perform a first differential operation to the to-be-upgraded firmware based on the target firmware, and thereby generating a differential upgrade package. The first differential operation uses an algorithm such as a known bsdiff algorithm, a known hdiff algorithm, or other known/self-developed algorithms. The size of the differential upgrade package is far smaller than the size of the target firmware; for example, the size of the differential upgrade package is smaller than ten percent of the size of the target firmware, but the implementation of the present invention is not limited thereto. It is noted that the first differential operation alone is realized with known/self-developed technologies, and its detail falls beyond the scope of the present disclosure.
S130: using the server to perform a second differential operation to the target firmware based on the to-be-upgraded firmware, and thereby generating a differential restoration package. The second differential operation uses a known/self-developed algorithm (e.g., a known bsdiff algorithm, or a known hdiff algorithm). The size of the differential restoration package is far smaller than the size of the to-be-upgraded firmware; for example, the size of the differential restoration package is smaller than ten percent of the size of the to-be-upgraded firmware, but the implementation of the present invention is not limited thereto. It is noted that the second differential operation alone is realized with known/self-developed technologies, and its detail falls beyond the scope of the present disclosure.
S140: using the terminal device to download the differential upgrade package and the differential restoration package through a communication channel.
   An example of the communication channel is a wireless communication channel including at least one of a WiFi connection, a Bluetooth connection, and a mobile network connection, but the implementation of the present invention is not limited thereto.
S150: using the terminal device to perform an upgrade operation to the current firmware of the terminal device with the differential upgrade package so as to upgrade the current firmware to the target firmware, wherein the current firmware is changed into incompletely-upgraded firmware after the upgrade operation starts and before the upgrade operation finishes successfully.
   For example, after the upgrade operation starts and before the upgrade operation finishes successfully, a preceding part of the current firmware is upgraded while the remaining part(s) of the current firmware is/are not upgraded yet; accordingly, the preceding part and the remaining part(s) as a whole is treated as the incompletely-upgraded firmware.
S160: using the terminal device to verify whether the upgrade operation fails, and when the upgrade operation fails, using the terminal device to perform a restoration operation to the incompletely-upgraded firmware with backup of partial data of the current firmware and/or with the differential restoration package so as to restore the incompletely-upgraded firmware to the current firmware.
   For example, when the data of a first part of the current firmware (e.g., the data of the first to-be-upgraded block BlockO_1 in FIG. 2) has been backed up and the upgrade operation to the first part has failed, the terminal device performs the restoration operation with the backup of the first part to restore the first part, which means the unsuccessfully upgraded first part is restored to the original first part. For example, when a first part of the current firmware (e.g., the data of the first to-be-upgraded block BlockO_1 in FIG. 2) has been upgraded, a second part of the current firmware (e.g., the data of the second to-be-upgraded block BlockO_2 in FIG. 2) has been backed up, and the upgrade operation to the second part has failed, the terminal device performs the restoration operation with the backup of the second part to restore the second part, which means the unsuccessfully upgraded second part is restored to the original second part, and performs the restoration operation with the differential restoration package to restore the first part, which means the successfully upgraded first part is restored to the original first part.

FIG. 2 shows an embodiment of step S120 of FIG. 1. Referring to FIG. 2, the to-be-upgraded firmware 210 can be divided into a plurality of blocks (hereinafter referred to as “N to-be-upgraded blocks”). The N to-be-upgraded blocks include a first to-be-upgraded block, a second to-be-upgraded block, a third to-be-upgraded block, a fourth to-be-upgraded, . . . , an (N−1)^{th} to-be-upgraded block, and an N^{th} to-be-upgraded block (i.e., BlockO_1, BlockO_2, BlockO_3, BlockO_4, . . . , BlockO_(N−1), and BlockO_N in FIG. 2), wherein the N is an integer greater than one. The target firmware 220 can be divided into a plurality of blocks (hereinafter referred to “N target blocks”). The N target blocks include a first target block, a second target block, a third target block, a fourth target block, . . . , an (N−1)^{th} target block, and an N^{th} target block (i.e., BlockD_1, BlockD_2, BlockD_3, BlockD_4, . . . , BlockD_(N−1), and BlockD_N in FIG. 2). The first differential operation includes a differential operation between each of the N target blocks and the N to-be-upgraded blocks BlockO_1˜BlockO_N; in other words, the first differential operation includes N differential operations in total, and each of the N differential operations is devoted to determining the difference between one target block (e.g., any target block such as BlockD_4 in FIG. 2) and all the to-be-upgraded blocks BlockO_1˜BlockO_N. It is noted that in an exemplary implementation each of the N differential operations is devoted to determining the difference between one target block (e.g., a K^{th} target block, wherein the K is a positive integer not greater than the N) and partial to-be-upgraded blocks (e.g., block(s) from the K^{th} to-be-upgraded block to the N^{th} to-be-upgraded block), if practicable.

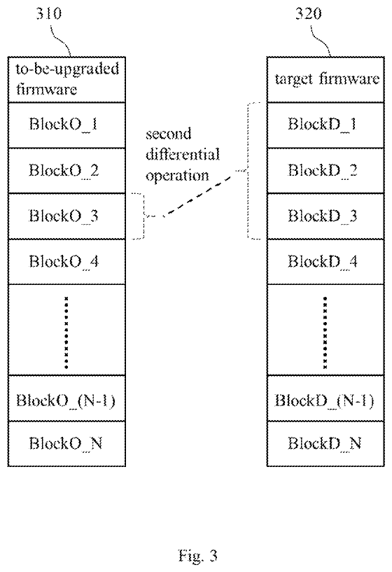

FIG. 3 shows an embodiment of step S130 of FIG. 1. Referring to FIG. 3, the to-be-upgraded firmware 310 can be divided into a plurality of blocks (hereinafter referred to as “N to-be-upgraded blocks”). The N to-be-upgraded blocks are from a first to-be-upgraded block to an N^{th} to-be-upgraded block (i.e., BlockO_1˜BlockO_N in FIG. 3) in turn, wherein the N is a positive integer greater than one. The target firmware 320 can be divided into a plurality of blocks (hereinafter referred to as “N target blocks”). The N target blocks are from a first target block and an N^{th} target block (i.e., BlockD_1˜BlockD_N in FIG. 3) in turn. The second differential operation includes N differential operations. A K^{th} differential operation of the N differential operations is between a K^{th} to-be-upgraded block (e.g., any block such as the third to-be-upgraded block BlockO_3 in FIG. 3) and K target block(s) (e.g., three blocks from the first target block BlockD_1 to the third target block BlockD_3 in FIG. 3), wherein the K is a positive integer not greater than the N. The K target block(s) are from a first target block to a K^{th} target block.

It is noted that in consideration of that the spared storage space of the terminal device could be insufficient, the to-be-upgraded firmware 210 is divided into the plurality of blocks and the target firmware 220 is divided into the plurality of blocks. In the above-mentioned way, step S150 of FIG. 1 can use the differential upgrade package to perform the upgrade operation to a plurality of blocks of the current firmware, that are equal to or equivalent to the plurality of blocks of the to-be-upgraded firmware, one by one and thereby prevent the upgrade operation from consuming too much storage space of the terminal device at a time; and step S160 can use the differential restoration package to perform the restoration operation to a plurality of blocks of the incompletely-upgraded firmware one by one and thereby prevent the restoration operation from consuming too much storage space of the terminal device at a time. However, provided the spared storage space of the terminal device is sufficient, it is not necessary to divide the firmware into a plurality of blocks. It is also noted that any two of the N to-be-upgraded blocks may have the same size or different sizes, the size of each to-be-upgraded block can be determined according to the amount of the spared storage space of the terminal device or determined according to other known/self-developed conditions (e.g., the unitary erase/write area of the storage media of the terminal device), and the size of the K^{th} to-be-upgraded block of the N to-be-upgraded blocks is the same as the size of the K^{th} target block of the N target blocks; however, the implementations of the present invention are not limited to the above features provided such implementations are practicable.

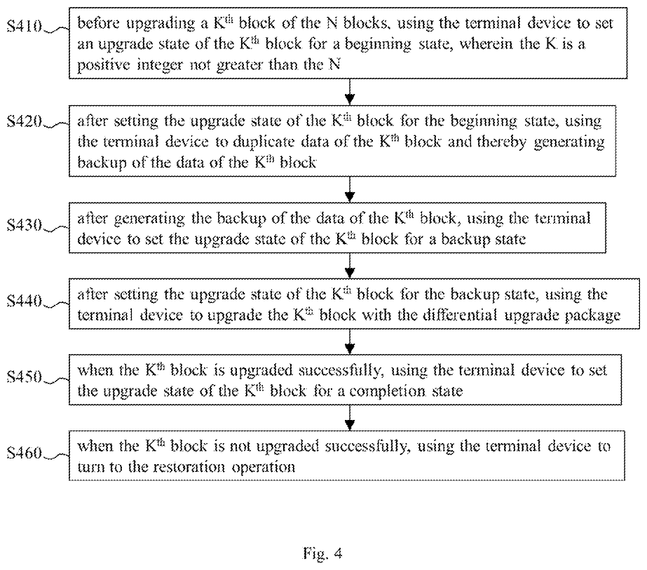

FIG. 4 shows an embodiment of step S150 of FIG. 1. Regarding the embodiment of FIG. 4, the current firmware is divided into N blocks, wherein the N is an integer greater than one. The N blocks are from a first block to an N^{th} block. Each of the N blocks represents firmware data of a storage block. On the basis of the above, step S150 (or alternatively the upgrade operation) includes: using the terminal device to upgrade the N blocks one by one with the differential upgrade package. To be more specific, as shown in FIG. 4, step S150 (or alternatively the upgrade operation) includes the following steps:
S410: before upgrading a K^{th} block of the N blocks, using the terminal device to set an upgrade state of the K^{th} block for a beginning state, wherein the K is a positive integer not greater than the N.
S420: after setting the upgrade state of the K^{th} block for the beginning state, using the terminal device to duplicate data of the K^{th} block and thereby generating backup of the data of the K^{th} block.
S430: after generating the backup of the data of the K^{th} block, using the terminal device to set the upgrade state of the K^{th} block for a backup state.
S440: after setting the upgrade state of the K^{th} block for the backup state, using the terminal device to upgrade the K^{th} block with the differential upgrade package.
   In an exemplary implementation, step S440 includes: generating upgraded firmware data of the K^{th} block according to firmware data relevant to the K^{th} block (e.g., data of all the N blocks of the current firmware, wherein the already-upgraded block(s) among the N blocks is/are temporarily recovered by using the differential restoration package before the block(s) is/are used for generating the upgraded firmware data; or data of (N−K+1) blocks of the current firmware from the K^{th} block to the N^{th} block) and the differential upgrade package; and after successfully generating the upgraded firmware data of the K^{th} block, overwriting the data of the K^{th} block with the upgraded firmware data of the K^{th} block. In this way, the terminal device doesn't need to reserve the data of the K^{th} block after the overwriting operation, which reduces the consumption of storage space of the terminal device.
S450: when the K^{th} block is upgraded successfully, using the terminal device to set the upgrade state of the K^{th} block for a completion state.
   It is noted that after the upgrade state of the K^{th} block is set for the completion state, the backup of the data of the K^{th} block can be deleted to reduce the consumption of storage space of the terminal device; however, the implementation of the present invention is not limited to the above features.
S460: when the K^{th} block is not upgraded successfully, using the terminal device to turn to the restoration operation.

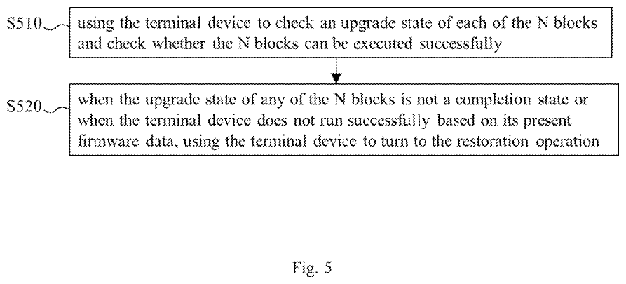

FIG. 5 shows additional steps optionally included in step S150 of FIG. 1. The steps in FIG. 5 are based on the embodiment of FIG. 4. Referring to FIG. 5, after the upgrade operation starts and before it finishes successfully, if the terminal device reboots for some reasons (e.g., power failure or user operations), step S150 (or alternatively the upgrade operation) further includes the following steps:
S510: using the terminal device to check an upgrade state of each of the N blocks and check whether the N blocks can be executed successfully.
S520: when the upgrade state of any of the N blocks is not a completion state or when the terminal device does not run successfully based on its present firmware data, using the terminal device to turn to the restoration operation.

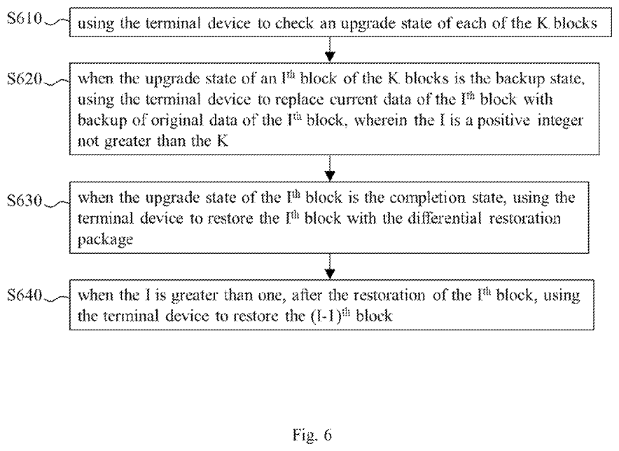

FIG. 6 shows an embodiment of step S160 of FIG. 1. The embodiment of FIG. 6 is based on the embodiment of FIG. 4. On the basis of the above, when the K is greater than one, step S160 (or alternatively the restoration operation) includes: when the K^{th} block is not upgraded successfully, using the terminal device to perform the restoration operation to K blocks with the backup of the data of the K^{th} block and with the differential restoration package, wherein the K blocks are from the K^{th} block to the first block. To be more specific, as shown in FIG. 6, step S160 (or alternatively the restoration operation) includes the following steps:
S610: using the terminal device to check an upgrade state of each of the K blocks.
S620: when the upgrade state of an I^{th} block of the K blocks is the backup state, using the terminal device to replace current data of the I^{th} block with backup of original data of the I^{th} block, wherein the I is a positive integer not greater than the K.
S630: when the upgrade state of the I^{th} block is the completion state, using the terminal device to restore the I^{th} block with the differential restoration package.
S640: when the I is greater than one, after the restoration of the I^{th} block, using the terminal device to restore the (I−1)^{th} block.
   It is noted that the K blocks are restored with steps S610˜S640 one by one from the K^{th} block to the first block.

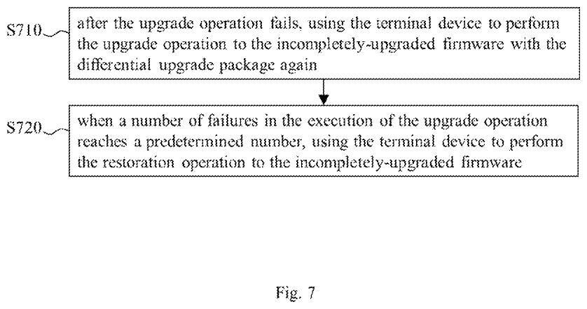

FIG. 7 shows additionally steps optionally included in step S160 of FIG. 1. As shown in FIG. 7, step S160 (or alternatively the restoration operation) further includes the following steps:
S710: after the upgrade operation fails, using the terminal device to perform the upgrade operation to the incompletely-upgraded firmware with the differential upgrade package again.
S720: when a number of failures in the execution of the upgrade operation reaches a predetermined number, using the terminal device to perform the restoration operation to the incompletely-upgraded firmware.

Another embodiment of the firmware update method of the present disclosure is executed by the terminal device, and includes steps S140, S150, and S160 of FIG. 1. In comparison with the embodiment of FIG. 1, the present embodiment has no limitations on the way to generate the differential upgrade package and the differential restoration package; in other words, any method that can generate the differential upgrade package and the differential restoration package is applicable to the present embodiment. Since those having ordinary skill in the art can refer to the embodiments of FIGS. 1˜7 to appreciate the details and the modifications of the present embodiment, repeated and redundant description is omitted here.

It is noted that people having ordinary skill in the art can selectively use some or all of the features of any embodiment in this specification or selectively use some or all of the features of multiple embodiments in this specification to implement the present invention as long as such implementation is practicable; in other words, the way to realize the present invention is flexible based on the present disclosure.

To sum up, the firmware update method having a self-restoration mechanism of the present disclosure is a useful differential upgrade method. The method keeps the advantages of differential upgrade while preventing a terminal device from crashing when the terminal device fails in its firmware update.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A firmware update method having a self-restoration mechanism and being performed by a server and a terminal device cooperatively, the firmware update method comprising:
using the server to obtain to-be-upgraded firmware that is equal to or equivalent to current firmware of the terminal device, and obtain target firmware;
using the server to perform a first differential operation to the to-be-upgraded firmware based on the target firmware, and thereby generating a differential upgrade package;
using the server to perform a second differential operation to the target firmware based on the to-be-upgraded firmware, and thereby generating a differential restoration package;
using the terminal device to download the differential upgrade package and the differential restoration package through a communication channel;
using the terminal device to perform an upgrade operation to the current firmware of the terminal device with the differential upgrade package so as to upgrade the current firmware to the target firmware, wherein the current firmware is changed into incompletely-upgraded firmware after the upgrade operation starts and before the upgrade operation finishes successfully; and
using the terminal device to verify whether the upgrade operation fails, and when the upgrade operation fails, using the terminal device to perform a restoration operation to the incompletely-upgraded firmware with backup of partial data of the current firmware and/or with the differential restoration package so as to restore the incompletely-upgraded firmware to the current firmware.

2. The firmware update method of claim 1, wherein the to-be-upgraded firmware is divided into N to-be-upgraded blocks, the N to-be-upgraded blocks are from a first to-be-upgraded block to an N^{th} to-be-upgraded block in turn, and the N is an integer greater than one; the target firmware is divided into N target blocks, and the N target blocks are from a first target block to an N^{th} target block; the first differential operation includes a differential operation between each of the N target blocks and the N to-be-upgraded blocks; and the second differential operation includes a differential operation between a K^{th} to-be-upgraded block and K target block(s), the K is a positive integer not greater than the N, and the K target block(s) is/are from the first target block to a K^{th} target block.

3. The firmware update method of claim 1, wherein the current firmware is divided into N blocks, the N blocks are from a first block to an N^{th} block in turn, each of the N blocks represents firmware data of a storage block, the N is an integer greater than one, and the upgrade operation includes: using the differential upgrade package to upgrade the N blocks in turn.

4. The firmware update method of claim 3, wherein the upgrade operation includes:
before upgrading a K^{th} block of the N blocks, setting an upgrade state of the K^{th} block for a beginning state, wherein the K is a positive integer not greater than the N;
after setting the upgrade state of the K^{th} block for the beginning state, duplicating data of the K^{th} block to generate backup of the data of the K^{th} block;
after generating the backup of the data of the K^{th} block, setting the upgrade state of the K^{th} block for a backup state;
after setting the upgrade state of the K^{th} block for the backup state, using the differential upgrade package to upgrade the K^{th} block;
when the K^{th} block is upgraded successfully, setting the upgrade state of the K^{th} block for a completion state; and
when the K^{th} block is not upgraded successfully, turning to the restoration operation.

5. The firmware update method of claim 4, wherein using the differential upgrade package to upgrade the K^{th} block includes: generating upgraded firmware data of the K^{th} block according to firmware data relevant to the K^{th} block and the differential upgrade package; and after generating the upgraded firmware data of the K^{th} block successfully, overwriting firmware data of the K^{th} block with the upgraded firmware data of the K^{th} block.

6. The firmware update method of claim 4, wherein the restoration operation includes: when the K^{th} block is not upgraded successfully, performing the restoration operation to the K^{th} block with the backup of the data of the K^{th} block.

7. The firmware update method of claim 4, wherein the K is greater than one, and the restoration operation includes: when the K^{th} block is not upgraded successfully, performing the restoration operation to K blocks with the backup of the data of the K^{th} block and the differential restoration package, wherein the K blocks are from the K^{th} block to the first block.

8. The firmware update method of claim 7, wherein the restoration operation includes:
checking an upgrade state of each of the K blocks;
when the upgrade state of an I^{th} block of the K blocks is the backup state, replacing current data of the I^{th} block with backup of original data of the I^{th} block, wherein the I is a positive integer not greater than the K; and
when the upgrade state of the I^{th} block is the completion state, restoring the I^{th} block with the differential restoration package.

9. The firmware update method of claim 3, wherein after the upgrade operation starts and before the upgrade operation finishes successfully, if the terminal device reboots, the upgrade operation includes: checking an upgrade state of each of the N blocks and checking whether the N blocks are executed successfully; and when the upgrade state of any of the N blocks is not a completion state or when the terminal device does not run successfully based on present firmware data of the terminal device, turning to the restoration operation.

10. The firmware update method of claim 1, further comprising:
after the upgrade operation fails, using the terminal device to perform the upgrade operation to the incompletely-upgraded firmware with the differential upgrade package again; and
when a number of failures in execution of the upgrade operation reaches a predetermined number, using the terminal device to perform the restoration operation to the incompletely-upgraded firmware.

11. A firmware update method having a self-restoration mechanism and being performed by a terminal device, the firmware update method comprising:
using the terminal device to download a differential upgrade package and a differential restoration package through a communication channel;
using the terminal device to perform an upgrade operation to current firmware of the terminal device with the differential upgrade package so as to upgrade the current firmware to the target firmware, wherein the current firmware is changed into incompletely-upgraded firmware after the upgrade operation starts and before the upgrade operation finishes successfully; and
using the terminal device to verify whether the upgrade operation fails, and when the upgrade operation fails, using the terminal device to perform a restoration operation to the incompletely-upgraded firmware with backup of partial data of the current firmware and/or with the differential restoration package so as to restore the incompletely-upgraded firmware to the current firmware.

12. The firmware update method of claim 11, wherein the communication channel is a wireless channel of a wireless communication network.

13. The firmware update method of claim 11, wherein the current firmware is divided into N blocks, the N blocks are from a first block to an N^{th} block in turn, each of the N blocks represents firmware data of a storage block, the N is an integer grater than one, and the upgrade operation includes: using the differential upgrade package to upgrade the N blocks in turn.

14. The firmware update method of claim 13, wherein the upgrade operation includes:
before upgrading a K^{th} block of the N blocks, setting an upgrade state of the K^{th} block for a beginning state, wherein the K is a positive integer not greater than the N;
after setting the upgrade state of the K^{th} block for the beginning state, duplicating data of the K^{th} block to generate backup of the data of the K^{th} block;
after generating the backup of the data of the K^{th} block, setting the upgrade state of the K^{th} block for a backup state;
after setting the upgrade state of the K^{th} block for the backup state, using the differential upgrade package to upgrade the K^{th} block;
when the K^{th} block is upgraded successfully, setting the upgrade state of the K^{th} block for a completion state; and
when the K^{th} block is not upgraded successfully, turning to the restoration operation.

15. The firmware update method of claim 14, wherein using the differential upgrade package to upgrade the K^{th} block includes: generating upgraded firmware data of the K^{th} block according to firmware data relevant to the K^{th} block and the differential upgrade package; and after generating the upgraded firmware data of the K^{th} block successfully, overwriting firmware data of the K^{th} block with the upgraded firmware data of the K^{th} block.

16. The firmware update method of claim 14, wherein the restoration operation includes: when the K^{th} block is not upgraded successfully, performing the restoration operation to the K^{th} block with the backup of the data of the K^{th} block.

17. The firmware update method of claim 14, wherein the K is greater than one, and the restoration operation includes: when the K^{th} block is not upgraded successfully, performing the restoration operation to K blocks with the backup of the data of the K^{th} block and the differential restoration package, wherein the K blocks are from the K^{th} block to the first block.

18. The firmware update method of claim 17, wherein the restoration operation includes:
checking an upgrade state of each of the K blocks;
when the upgrade state of an I^{th} block of the K blocks is the backup state, replacing current data of the I^{th} block with backup of original data of the I^{th} block, wherein the I is a positive integer not greater than the K; and
when the upgrade state of the I^{th} block is the completion state, restoring the I^{th} block with the differential restoration package.

19. The firmware update method of claim 13, wherein after the upgrade operation starts and before the upgrade operation finishes successfully, if the terminal device reboots, the upgrade operation includes: checking an upgrade state of each of the N blocks and checking whether the N blocks are executed successfully; and when the upgrade state of any of the N blocks is not a completion state or when the terminal device does not run successfully based on present firmware data of the terminal device, turning to the restoration operation.

20. The firmware update method of claim 11, further comprising:
after the upgrade operation fails, using the terminal device to perform the upgrade operation to the incompletely-upgraded firmware with the differential upgrade package again; and
when a number of failures in execution of the upgrade operation reaches a predetermined number, using the terminal device to perform the restoration operation to the incompletely-upgraded firmware.
